(19) United States
(12) Patent Application Publication
(10) Pub. No.: US 2009/0092018 A1
(43) Pub. Date: Apr. 9, 2009

(54) RECORDING MODULATION CIRCUIT, RECORDING MODULATION METHOD AND OPTICAL DISK APPARATUS

(76) Inventors: Misuzu MOCHIZUKI, Yokohama (JP); Koichiro NISHIMURA, Yokohama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 12/244,943

(22) Filed: Oct. 3, 2008

(30) Foreign Application Priority Data
Oct. 5, 2007 (JP) 2007-261701
Aug. 22, 2008 (JP) 2008-214549

(51) Int. Cl. G11B 20/18

(52) U.S. Cl. 369/53.17

(57) ABSTRACT

After a transfer error detection circuit detects a transfer error that transfer data from a memory controller to a recording modulation circuit is delayed for a recording clock process, the number of transfer errors is counted in units of sync frame in a transfer error count circuit. When the number of transfer errors is n times (n: positive integer) or less, the modulation and recording operation are continued as it is and the NRZI output operation is performed from the correct position while applying a sync, and when the number of transfer errors is n times or larger, the recording operation is interrupted and the re-recording is performed from the interrupted location thereafter.

### CROSS-REFERENCE TO RELATED APPLICATION

The present application claims priority from Japanese Patent Application No. JP 2007-261701 filed on Oct. 5, 2007 and Japanese Patent Application No. JP 2008-214549 filed on Aug. 22, 2008, the contents of which are hereby incorporated by reference into this application.

### TECHNICAL FIELD OF THE INVENTION

The present invention relates to a technology effectively applied to a recording modulation circuit and a recording modulation method used in recording digital data on an optical disk and an optical disk apparatus provided with the recording modulation circuit.

### BACKGROUND OF THE INVENTION

Japanese Patent Application Laid-Open Publication No. 2003-59184 ((FIG. 1 to FIGS. 5A and 5B) patent document 1) discloses a method in which the amount of positional shift is detected and a sync width included in the recorded data is controlled in accordance with the detected amount in order to re-record on a recordable optical disk media such as DVD-R and DVD-RW. In this method, when the recording is interrupted at an intermediate position of the sync frame and temporally-discontinuous next data is newly recorded from the recording-interrupted position, the improper reproduction of the newly recorded data is prevented. Also, the wasteful region in writing the dummy data in the re-recording is reduced.

Japanese Patent Application Laid-Open Publication No. 2002-111513 ((FIG. 1 and FIG. 17) patent document 2) describes an ECC (Error Collection Code) block structure having high burst error correction capability. The burst error is an error that occurs in continuous data, and mainly arises from scratches and contamination. In the DVD, an error correction code using iterated code is adopted. A unit of a predetermined size used in error correction is called the ECC block. If two ECC blocks used in the DVD are disposed horizontally as described in patent document 2, the burst error correction capability doubles compared to the ECC structure of the conventional DVD.

If the burst error exists in the reproduced data due to scratches and contamination on the medium, the burst error doubles when the recording line density is doubled. For instance, if the bit length of the DVD-RAM is 0.28 μm and the bit length of the HD DVD (registered trademark) is 0.13 μm, the maximum length of the correctable burst error is 2741 bytes (about 6 mm) in DVD and 5904 bytes (about 6 mm) in the HD DVD with the configuration of patent document 2. The actual HD DVD adopts the interleave configuration, and thus has stronger resistance to the burst error.

FIG. 27 of Japanese Patent Application Laid-Open Publication No. 2004-241044 (patent document 3) describes the ECC block in HD DVD. Also, FIG. 34 of patent document 3 describes the data structure of the ECC block. One ECC block consists of 32 sectors, and one sector consists of 26 sync frames. Further, FIG. 29 of patent document 3 describes the sector structure. The 24-bit sync is inserted for every 1092-bit data. Since the order of four types of sync (SY0 to SY3) is determined, the data of which sync frame can be known by detecting the sync.

Further, FIG. 42 of patent document 3 describes the recording method of the rewritable data. The data recording in the HD DVD disk is performed in units of recording cluster. The physical address is embedded in a wobble surface in units of physical segment block.

### SUMMARY OF THE INVENTION

As described in patent document 2, since the error correction is performed in units of ECC block in reproducing the disk, the data recorded on the disk needs to be continuous data, and normal reproduction becomes difficult if the data is lost or the data order is moved up.

Therefore, the recording operation is generally interrupted in such a case where the continuous data cannot be recorded, and the method of re-recording as described in patent document 1 is adopted. The cause of interrupting the recording includes external factors such as vibration from the outside to the optical head, tracking deviation in which the laser spot deviates from the control range in the track direction by impact, focus deviation in which the position of the objective lens in the focus direction deviates from the control range, degradation of laser, and buffer underrun (write is automatically stopped when the buffer becomes empty).

On the other hand, as the cause of interrupting the recording in the circuit, when the transfer data from the memory controller to the recording modulation circuit is delayed for the recording clock, transfer error is output to interrupt the recording operation so that erroneous data is not recorded on the disk.

In the optical disk apparatus, generally, scramble process and correction code adding process are performed using the DRAM in order to generate the ECC block as described in patent document 2. The memory controller is used for data input control via the ATAPI interface, the DRAM data output control to the recording modulation circuit, the scramble process, and the correction code adding process. The clock of the circuit in the periphery of the memory controller uses a master clock using a crystal oscillator.

When the process in the memory controller suddenly increases or when a number of interruptions from the microcomputer are provided, the transfer error may occur sporadically and incidentally. In the optical disk apparatus, after a request for data input is output to the memory controller from the recording modulation circuit, the number of buffers is determined so that data larger than the data amount transferable during standby time until the data is input to the memory controller can be held.

However, if the interruption unexpectedly occurs, the memory controller process increases, and the data is input from the memory controller to the recording modulation circuit in the time longer than the processing time defined by the number of buffers. In such a state, since the output of the NRZI (Non Return to Zero Invert) signal synchronized with the recording clock is interrupted, the transfer error is output.

FIG. 10(1) is a view showing the write gate and the NRZI in normal output in the optical disk apparatus of the prior art, and FIG. 10(2) is a view showing the write gate and the NRZI in the transfer error in the optical disk apparatus of the prior art. As shown in FIG. 10(2), in the optical disk apparatus of the prior art, if the transfer error occurs even only once, the modulation process is stopped and the write gate is invalidated so that the NRZI signal is not output to the laser drive circuit. Thereafter, the transfer error is canceled by reset, and the re-write starts from the location where the transfer error occurred. Therefore, a long time is necessary for recording.

In recent years, the DVD disk is operated at 20 times speed faster than 16 times speed which is considered as the limit of the DVD disk so as to use up to the performance limit of the circuit and the drive. As the speed becomes higher, the recording time can be shortened, and the recording disk creation time of the user can be reduced. For instance, in the case of the data requiring 60 minutes when recorded at normal (1×) speed, only 3 minutes are required if the data is recorded at 20 times speed. Such an improvement in recording speed has been strongly desired by the user not only for data but also in high-speed dubbing in the DVD recorder.

However, as described above, high-speed recording is difficult if the transfer error is output even only once. Further, the memory controller process becomes stricter as the recording speed is increased, and the possibility of causing sporadic and incidental transfer error due to unexpected factors is also increased.

Therefore, an object of the present invention is to provide an optical disk apparatus and a recording modulation circuit thereof capable of achieving the high-speed recording even if sporadic and incidental transfer error occurs at the time of data input from the memory to the recording modulation circuit, and providing margin to the memory process. In particular, an object of the present invention is to achieve the high-speed recording in the streaming recording in which images are directly recorded on the optical disk.

The above and other objects and novel characteristics of the present invention will be apparent from the description of this specification and the accompanying drawings.

The typical ones of the inventions disclosed in this application will be briefly described as follows.

In the optical disk apparatus according to a typical embodiment of the present invention, the number of transfer errors is counted in units of sync frame after the transfer data from the memory controller to the recording modulation circuit is delayed for the recording clock process and the transfer error is generated. If the number of transfer errors is less than n (n: positive integer), the modulation and the recording operation are continued as it is, and the sync is provided from the correct position to perform the NRZI output operation. On the other hand, if the number of transfer errors is n or more, the recording operation is interrupted, and the re-recording is restarted from the interrupted location.

The effects obtained by typical aspects of the present invention will be briefly described below.

According to the typical embodiment of the present invention, the high-speed recording can be achieved even if sporadic and incidental transfer error occurs at the time of data input from the memory to the recording modulation circuit, and margin can be provided to the memory process.

### BRIEF DESCRIPTIONS OF THE DRAWINGS

FIG. 1 is a block diagram of an optical disk apparatus according to a first embodiment of the present invention;

FIG. 2(1) is a view showing a configuration of a scramble frame in HD DVD;

FIG. 2(2) is a view showing a configuration of an ECC block in HD DVD;

FIG. 3(1) is a view showing a configuration of the ECC block after PO insertion in HD DVD;

FIG. 3(2) is a view showing a configuration of a recording frame in HD DVD;

FIG. 4(1) is a view showing the write gate and the NRZI in normal output according to the first embodiment of the present invention;

FIG. 4(2) is a view showing the write gate and the NRZI in transfer error generation according to the first embodiment of the present invention;

FIG. 5 is a flowchart of an operation when the transfer error is detected according to the first embodiment of the present invention;

FIG. 6(1) is a view showing a relationship between a write time and a linear velocity in CAV;

FIG. 6(2) is a view showing a relationship between a write time and an angular velocity in CLV;

FIG. 7(1) is a view showing the write gate and the NRZI in normal output according to a second embodiment of the present invention;

FIG. 7(2) is a view showing the write gate and the NRZI in transfer error generation according to the second embodiment of the present invention;

FIG. 7(3) is a view showing a memory address map according to the second embodiment of the present invention;

FIG. 8 is a view showing the write gate and the NRZI according to a third embodiment of the present invention;

FIG. 9 is a flowchart of an operation when the transfer error is detected according to a fourth embodiment of the present invention;

FIG. 10(1) is a view showing the write gate and the NRZI in normal output in the optical disk apparatus of the prior art;

FIG. 10(2) is a view showing the write gate and the NRZI in the transfer error generation in the optical disk apparatus of the prior art;

FIG. 11(1) is a view showing the write gate and the NRZI of the BD format after modulation according to a fifth embodiment of the present invention;

FIG. 11(2) is a view showing a configuration of the ECC block in the BD format; and

FIG. 12 is a block diagram of the optical disk apparatus according to the fifth embodiment of the present invention.

### DESCRIPTIONS OF THE PREFERRED EMBODIMENTS

Hereinafter, embodiments of the present invention will be described in detail with reference to the accompanying drawings. Note that components having the same function are denoted by the same reference numbers throughout the drawings for describing the embodiments, and the repetitive description thereof will be omitted.

### First Embodiment

An optical disk apparatus according to a first embodiment of the present invention will be described below.

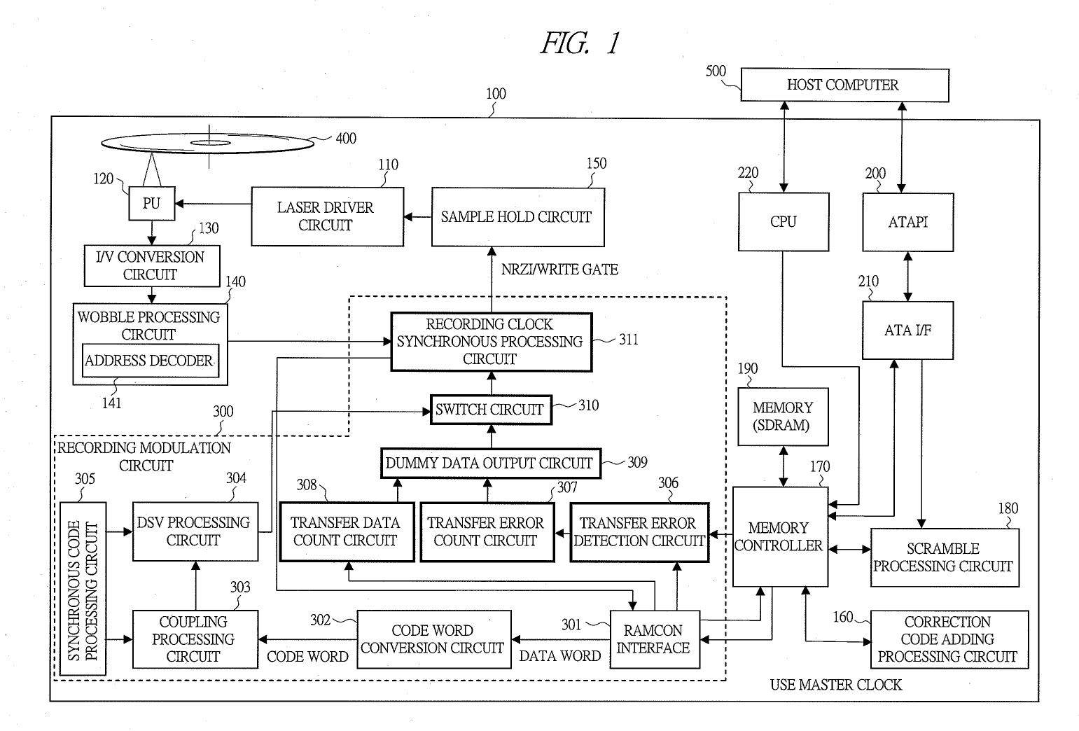

FIG. 1 is a block diagram of an optical disk apparatus of the present embodiment. In FIG. 1, the optical disk apparatus 100 is configured to include a laser driver circuit 110, an optical head (PU) 120, an I/V conversion circuit 130, a wobble processing circuit 140, a sample hold circuit 150, a correction code adding processing circuit 160, a memory controller 170, a scramble processing circuit 180, a memory 190, an ATAPI 200, an ATAPI interface (ATA I/F) 210, a CPU 220, and a recording modulation circuit 300. Further, the wobble processing circuit 140 includes an address decoder 141.

Here, the recording modulation circuit 300 is a circuit which performs modulation in accordance with the modulation scheme for modulating a data word of i bits (i is a positive integer) to a code word of j bits (j is a positive integer), and outputs the modulated output data of a format in which a sync code is inserted at equal interval between the code words. Also, the wobble processing circuit 140 is a circuit which extracts a wobble signal corresponding to a periodically meandering wobble groove (recording guide groove) of the optical disk 400 and outputs a recording clock as a binary signal synchronized with the wobble signal.

Further, the address decoder 141 is a circuit which determines whether the address extracted from the wobble groove is the recording position address, and outputs the recording position detection signal indicating the recording position to the recording modulation circuit 300. Also, the laser drive circuit 110 is a circuit which controls the laser light to record the modulated output data on the optical disk 400. Also, the memory 190 temporarily stores the data word, and the memory controller 170 reads out the data word from the memory 190 and outputs the same to the recording modulation circuit 300.

The recording modulation circuit 300 is configured to include a memory controller (RAMCON) interface 301, a code word conversion circuit 302, a coupling processing circuit 303, a DSV (Digital Sum Value) processing circuit 304, a synchronous code processing circuit 305, a transfer error detection circuit 306, a transfer error count circuit 307, a transfer data count circuit 308, a dummy data output circuit 309, a switch circuit 310, and a recording clock synchronous processing circuit 311.

Here, the recording clock synchronous processing circuit 311 is a circuit which converts the modulated code word to code data such as NRZI and outputs the same as a laser drive signal in synchronization with the recording clock. Also, the transfer error detection circuit 306 is a circuit which detects the transfer error when the data word input from the memory controller 170 is deviated from a timing requested by the recording clock synchronous processing circuit 311. Further, the transfer error count circuit 307 is a circuit which counts the number of transfer errors detected by the transfer error detection circuit 306 for every sync frame, and the transfer data count circuit 308 is a circuit which counts the data word input from the memory controller 170.

Note that each of the circuits configuring the recording modulation circuit 300 may be an independent circuit obtained by a single circuit or a plurality of combined circuits. Further, the process in each circuit may be executed by software process in the CPU 220.

As shown in FIG. 1, the optical disk apparatus 100 is connected to a host computer 500 such as personal computer or work station. The command and the information data from the host computer 500 are input to the CPU 220, and the recording operation and the reproducing operation of the information on an optical disk 400 such as HD DVD-R/RW and the seek operation of moving the optical head 120 to a target track are executed by the control of the CPU 220. Hereinafter, each of the operation contents of the optical disk apparatus 100 of the present embodiment having the above-mentioned configuration will be described.

[Reproducing Operation]

First, the reproducing operation in the optical disk apparatus 100 according to the present embodiment will be described.

The optical disk apparatus 400 is rotatably driven by a spindle motor. A semiconductor laser in the optical head 120 irradiates laser light for reproducing the information. The optical system of the optical head 120 forms the emitted light from the semiconductor laser as a light spot on the surface of the optical disk 400. Further, the photodetector in the optical head 120 converts the reflected light from the optical disk 400 to an electric signal. A light spot control such as focus control or tracking control and reproduction of information are performed using the converted electric signal.

[Recording Operation]

Next, the recording operation in the optical disk apparatus 100 of the present embodiment will be described.

First, the recording start instruction is input from the host computer 500 to the CPU 220. Next, the reproducing operation mentioned above is executed, and the electric signal based on the reflected light of the optical disk 400 is output from the optical head 120. The electric signal is subjected to the current-voltage conversion in the I/V conversion circuit 130 and input to the wobble processing circuit 140.

The wobble processing circuit 140 extracts a wobble signal corresponding to the wobble groove provided on the recording surface of the optical disk 400. The binary signal synchronized with the wobble signal is output to the recording clock synchronous processing circuit 311 in the recording modulation circuit 300 as the recording clock. Also, the wobble address is detected from the wobble signal by the address decoder 141 in the wobble processing circuit 140. When the address of the recording target on the optical disk 400 set in the CPU 220 is detected, the gate signal indicating the recording position is output to the recording clock synchronous processing circuit 311.

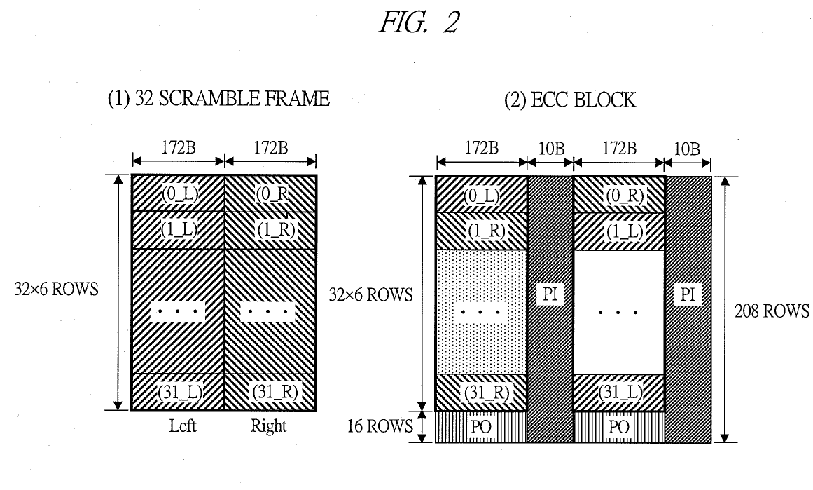

Thereafter, data subjected to such processes as ID adding process, scramble processing, correction code adding process by the memory 190, the scramble processing circuit 180, and the correction code adding processing circuit 160 is output from the memory controller 170 to the recording modulation circuit 300. FIG. 2(1) shows a configuration of the scramble frame in the HD DVD and FIG. 2(2) shows a configuration of the ECC block in the HD DVD. In the ECC block, the interleave configuration in which scramble is performed so that the same data does not continue is adopted, and the PO (Parity of Outer code) and PI (Parity of Inner code) are added so that error correction can be performed even if there are random error and burst error.

The memory controller 170 outputs every eight bits(=1 byte) of the data of the memory 190 to the code word conversion circuit 302 in the recording modulation circuit 300 as the data word via the RAMCON interface 301. The data word is input to the code word conversion circuit 302, and 8-12 modulation for converting the 8 bits to 12 bits of code word in accordance with a predetermined modulation rule is performed. Thereafter, the process of suppressing the succession of data array of “01” in the code word to 5 times or less (coupling rule process) is performed based on the substitution rule in the coupling processing circuit 303.

If the DSV (Digital Sum Value) control bit # exists in the code word output from the coupling processing circuit 303, the DSV processing circuit 304 provides “0” or “1” to the DSV control bit # in the code word so that DSV approaches zero. The DSV control is a control for suppressing the low-frequency component of the modulation signal, in which “1” in the code word is set to +1 and “0” is set to −1 so that the accumulated value approaches zero.

The code word of 12 bits subjected to the DSV process in the DSV processing circuit 304 is converted to NRZI in accordance with the timing of the recording position detection signal supplied from the address decoder 141 in the recording clock synchronous processing circuit 311 via the switch circuit 310, and then input to the sample hold circuit 150.

The sample hold circuit 150 performs a predetermined laser irradiation length control for each mark space width of the NRZI, and the output signal is output to the laser drive circuit 110 together with the recording clock. The laser drive circuit 110 supplies the drive current to the laser of the optical head 120. By the laser light irradiated from the laser, the digital data is recorded on the optical disk 400. Note that the laser drive circuit 110 may be disposed in the optical head 120.

[Circuit Operation Related to Transfer Error Detection]

Next, the circuit operation related to transfer error detection in the optical disk apparatus 100 according to the present embodiment will be described below.

In order to output the NRZI continuously from the recording clock synchronous processing circuit 311 to the sample hold circuit 150, the memory controller 170 performs a timing control of the output data to the RAMCON interface 301.

The RAMCON interface 301 has buffers in plural stages. The number of buffers is determined so that processing with the data in the buffer can be performed during a number of clocks longer than the standby time until the data is input from the memory controller 170 after outputting a request for data input from the RAMCON interface 301 to the memory controller 170.

The standby time is determined in accordance with the processing state of the memory controller 170. When a process of higher priority than the request from the recording modulation circuit 300 exists, the data input standby time in the recording modulation circuit 300 becomes long. Also, if priority of the process is lower than the request from the recording modulation circuit 300, the data input standby time in the recording modulation circuit 300 becomes short. When the number of clocks of the standby time becomes longer than the number of clocks determined by the number of buffers in the RAMCON interface 301, the NRZI output synchronized with the recording clock is interrupted, and the transfer error occurs.

At this time, the modulation enable signal output to the transfer error detection circuit 306 in the recording modulation circuit 300 from the memory controller 170 is turned from “H” to “L”, whereby the transfer error is detected by the transfer error detection circuit 306. Also, the transfer error count circuit 307 of the recording modulation circuit 300 counts the number of transfer errors by counting the transfer error detection signal output from the transfer error detection circuit 306 at a predetermined timing.

Note that the margin of the process of the memory controller 170 decreases as the recording speed of the optical disk apparatus 100 becomes higher.

[Input/Output Data of Recording Modulation Circuit]

Next, the input/output data of the recording modulation circuit 300 in the optical disk apparatus 100 according to the present embodiment will be described.

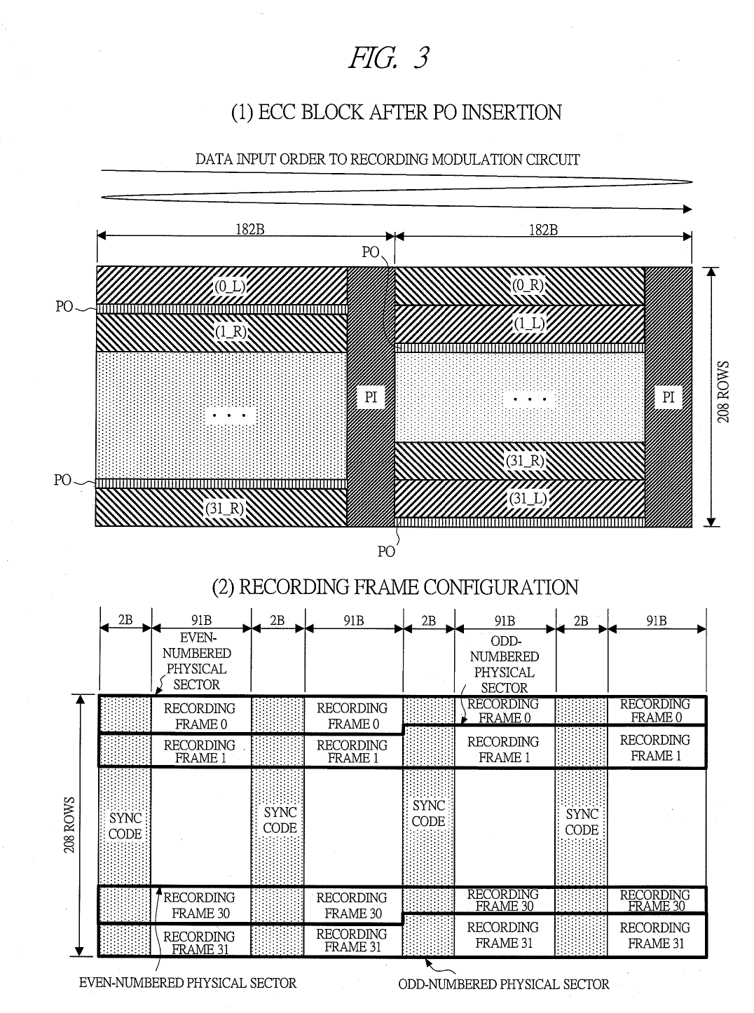

The memory controller 170 performs the control of input/output to the correction code adding processing circuit 160, the scramble processing circuit 180, the memory 190, the recording modulation circuit 300, and others, and it inputs the data to the recording modulation circuit 300 in accordance with the order shown in FIG. 3(1) through the RAMCON interface 301 by the request from the recording clock synchronous processing circuit 311 in the recording modulation circuit 300.

When the data is input from the memory controller 170 to the RAMCON interface 301 within a predetermined timing, the RAMCON interface 301 inputs the data word of each 8 bits (1 byte before modulation) to the code word conversion circuit 302. Thereafter, a predetermined modulation scheme is performed by the code word conversion circuit 302, a predetermined process is performed in the coupling processing circuit 303, the DSV processing circuit 304 and the synchronous code processing circuit 305, and the data for each 12 bits (1 byte after modulation) is input to the recording clock synchronous processing circuit 311 through the switch circuit 310.

The synchronous code processing circuit 305 inserts 2 bytes (24 bits) of the synchronous code (sync code) for every 91 bytes (1092 bits) with respect to the modulation data. FIG. 3(2) shows a configuration of the recording frame in which the sync code is inserted to the ECC block. The recording frame consists of a total of 32 sectors of even-numbered physical sectors and odd-numbered physical sectors.

Thereafter, the signal subjected to the DSV control by the DSV processing circuit 304 is input to the recording clock synchronous processing circuit 311 for every 12 bits via the switch circuit 310.

[Operation When Transfer Error is Not Detected]

Next, the operation when the transfer error is not detected in the optical disk apparatus 100 according to the present embodiment will be described.

When the transfer error is not detected in the transfer error detection circuit 306, the write gate is normally output from the recording clock synchronous processing circuit 311. At this time, a recording start position detection signal is output to the recording clock synchronous processing circuit 311 by the address decoder 141, and the recording clock synchronous processing circuit 311 outputs the write gate to the sample hold circuit 150 at a predetermined timing.

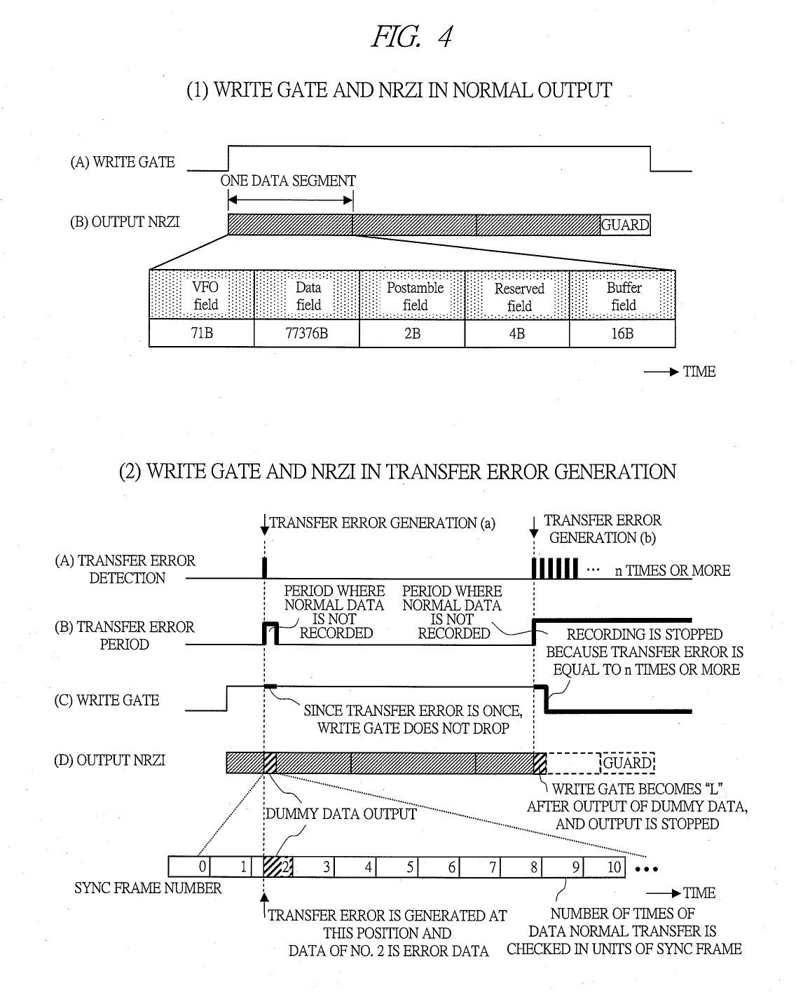

FIG. 4(1) is a view showing the write gate and the NRZI in normal output. The NRZI is output when the write gate indicating the recording operation is “H”. After N (N: positive integer) data segments continue, the guard is finally output. The recording frame corresponds to data filed in FIG. 4(1).

[Operation When Transfer Error is Detected]

The operation when the transfer error is detected in the optical disk apparatus 100 according to the present embodiment will be described.

FIG. 4(2) is a view showing the write gate and the NRZI when the transfer error is generated. At the time when the transfer error is generated, the transfer error detection signal output from the transfer error detection circuit 306 becomes “H”. The number of transfer errors from the generation of transfer error until the end of one sync frame is counted in the transfer error count circuit 307, and when the number of counts is smaller than n (n: positive integer), the write gate is not changed to “L” and remains “H” as shown in the timing of transfer error generation (a) of FIG. 4(2).

At this time, the dummy data is output as the output NRZI from the point of transfer error generation. The dummy data is obtained by inputting dummy data output from the dummy data output circuit 309 to the recording clock synchronous processing circuit 311 via the switch circuit 310 and converting the same to the output NRZI. It is not used in the actual data portion and sync code, and the unique dummy data identifiable therefrom is output so as to easily specify the error location.

The unique dummy data mentioned here may be a 12T repeating pattern in the case of HD DVD. The 12T repeating pattern is a pattern in which a pattern where “0” continues for consecutive 12 clocks and a pattern where “1” continues for consecutive 12 clocks alternately appear.

The maximum channel bit length T in HD DVD is 13T contained only in the sync code. Also, the maximum T of the data part is 11T, and the modulation scheme is defined so as to satisfy the run length rule RLL (1, 10). At this time, in the NRZ (Non Return to Zero), the number of “0” sandwiched between “1” is 1 or larger and 10 or smaller, and thus the NRZI is configured by signals of 2T to 11T. Therefore, the signal of the 12T repeating pattern is neither data nor sync code and is identifiable unique data. Further, since DSV of the 12T repeating pattern is 0, it can be detected without any problem by PLL (Phase Locked Loop) also in reproduction.

Even in the case of unique pattern other than the 12T repeating pattern, the signal complying with 8-12 modulation scheme is adopted in HD DVD, and normal reproduction is achieved. Although not shown, the PLL is used in reproduction and control for setting the DSV to 0 is performed to generate the reproduction clock, and thus reproduction clock can be normally generated by the PLL if the signal complies with the 8-12 modulation scheme. For example, the dummy data may be 4T repeating pattern similar to the guard part. The 4T repeating pattern in the NRZI is a pattern in which “1” continues for 4 clocks (“1111”) after “0” continues for 4 clocks (“0000”).

The case of setting the unique dummy data based on the modulation scheme in the HD DVD has been described above, but unique dummy data can be similarly set based on the corresponding modulation scheme also in the current DVD and the Blu-ray ((Registered trademark): BD).

Meanwhile, the number of transfer errors from the generation of transfer error until the end of one sync frame is counted by the transfer error count circuit 307, and when the number of counts is n (n: positive integer) or larger, as shown in the timing of the transfer error generation (b) of FIG. 4(2), the dummy data is output during the transfer error counting, and thereafter the write gate is set to “L” to interrupt the NRZI output, thereby stopping the recording operation.

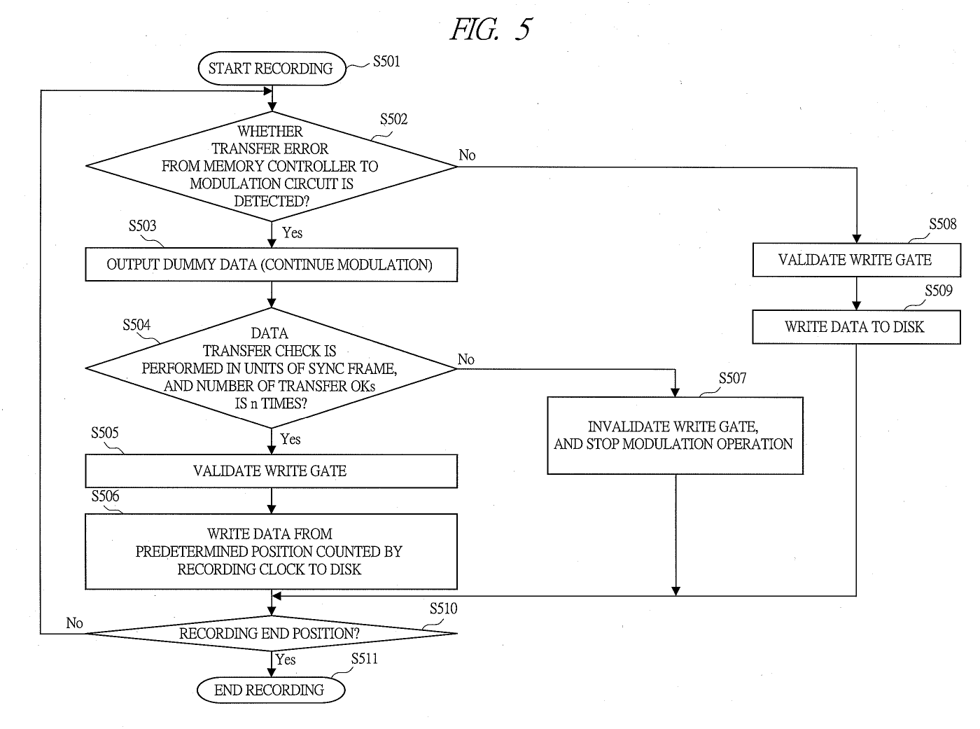

FIG. 5 is a flowchart of the operation when the transfer error is detected. After recording is started (step 501), whether or not the transfer error from the memory controller 170 to the recording modulation circuit 300 is generated is detected (step 502). The transfer error detection is carried out from the start of recording to the end of recording. If the transfer error is not detected, the write gate is validated (step 508) and the data write to the disk is carried out until the recording end position (step 509).

When the transfer error is detected (step 502), the NRZI output to the sample hold circuit 150 is output as the dummy data until the end point of one sync frame (step 503). The number of times of transfer error generated in one sync frame is detected (step 504), and the write gate is invalidated when it is equal to or larger than the set number of times (n times), so that the NRZI is not output (step 507).

When it is equal to or smaller than the set number of times (n times), the write gate is continuously validated (step 505). Thereafter, the NRZI added with synchronous code (sync code) is output from the correct position based on the transfer error (error that data cannot be input within a predetermined timing from the memory controller 170) and the number of transfer data from the memory controller 170 to the RAMCON interface 301, and it recorded in the optical disk 400 via the sample hold circuit 150 (step 506).

Then, it is determined whether or not the recording end position is reached (step 510), and the process returns to step 502 and continues if the recording end position is not reached. The recording is terminated if the recording end position is reached (step 511).

Note that the set number n (n: positive integer) of the number of transfer errors may be stored in the register, the memory and others, and further be changed by the operation from outside.

[Effect]

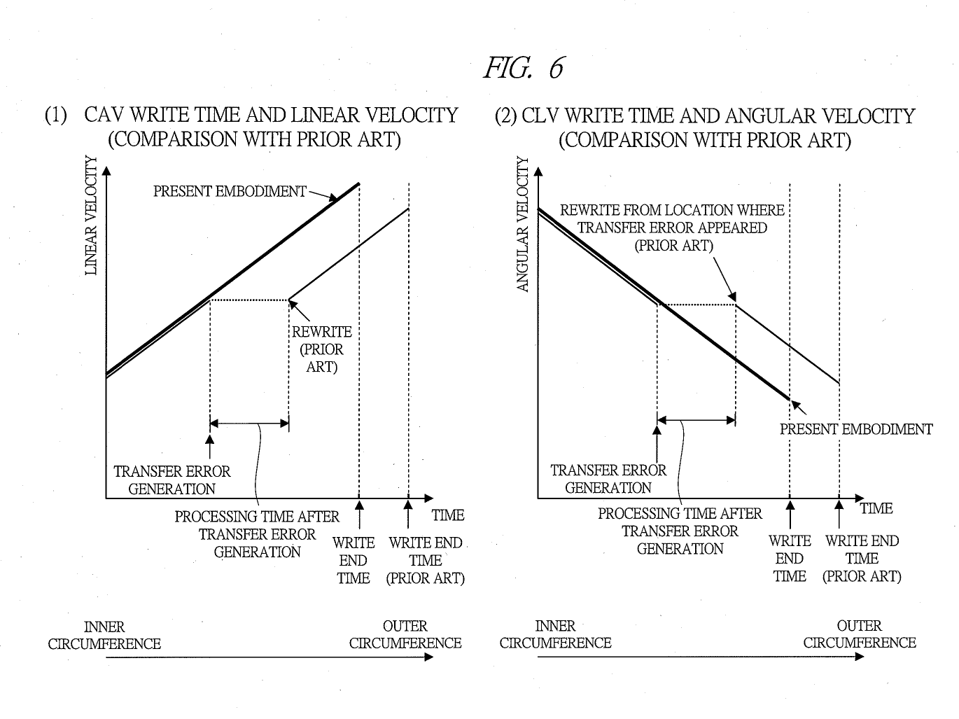

Conventionally, when one transfer error is generated, the recording operation is once interrupted, and the write is performed again from the recording position. FIG. 6(1) is a view showing a relationship of the write time and the line speed in CAV (Constant Angular Velocity). Also, FIG. 6(2) is a view showing a relationship between the write speed and the angular speed in CLV (Constant Linear Velocity).

In the conventional example, when the transfer error is detected once, after the linear velocity or the angular velocity is kept the same or the velocity is temporarily decreased, the write is started again. Therefore, the write time becomes long. In the optical disk apparatus 100 according to the present embodiment, when write is performed from the inner circumference to the outer circumference, high-speed write is continued when the transfer error is detected once, and thus the write time can be shortened compared to the prior art.

In the optical disk apparatus 100 of the present embodiment, a circuit configuration suited to the high-speed recording modulation process is provided as described above, and when the transfer error from the memory 190 to the recording modulation circuit 300 suddenly occurs, the number of transfer errors is checked in units of sync frame. By this means, when it is smaller than the predetermined number of times, since the data of the one sync frame of the portion where the transfer error has occurred is recorded as the dummy data on the optical disk 400, the high-speed recording is achieved.

Also, in reproduction, the dummy data portion is processed as the burst error. In the current DVD, the error can be corrected even if the burst (continuous) error of 2714B (29 sync frames) is generated and normal reproduction can be performed. In the HD DVD, burst error of at least 5904B (63 sync frames) can be corrected. Accordingly, although the data of at least one sync frame becomes incorrect dummy data, since the dummy data portion can be restored by error correction at the time of reproduction, the high-speed recording becomes possible.

In the use of the equipment mounted with the optical disk apparatus 100, for example, the real time properties are demanded for the stream data of the recorder and video camera because retake is not possible, and thus it is particularly effective to the case where the transfer error occurs sporadically. It is also possible to provide a switching function so that the function of high-speed recording as described in the present embodiment is not applied when it is mounted on an equipment in which the data reliability is demanded such as PC and the function of high-speed recording is applied when it is mounted on an equipment such as a recorder or a camera. Also, according to this configuration, the high-speed recording function can be used even in PC by switching the setting when it is desired to write the data at high speed.

In the optical disk apparatus 100 of the present embodiment, only the configuration using the HD DVD has been described, but processes similar to the above can be performed even in DVD and BD by simply changing the configuration of the modulation process in the recording modulation circuit 300.

### Second Embodiment

An optical disk apparatus according to the second embodiment will be described below.

The block diagram of the optical disk apparatus according to the present embodiment is similar to FIG. 1 of the first embodiment. In the optical disk apparatus 100 of the present embodiment, when the number of transfer errors in units of sync frame is larger than the predetermined number of times, the dummy data equivalent to one ECC block is output from the recording modulation circuit 300 to the sample hold circuit 150, and correct data is output from the next ECC block in the memory 190.

In this case, the correct code word is switched and output from the next ECC block by the data switch circuit 309 at the timing determined by the data count value of the transfer data count circuit 308 that is the number of times of normal data transfer from the memory controller 170 and the transfer error count value of the transfer error count circuit 307.

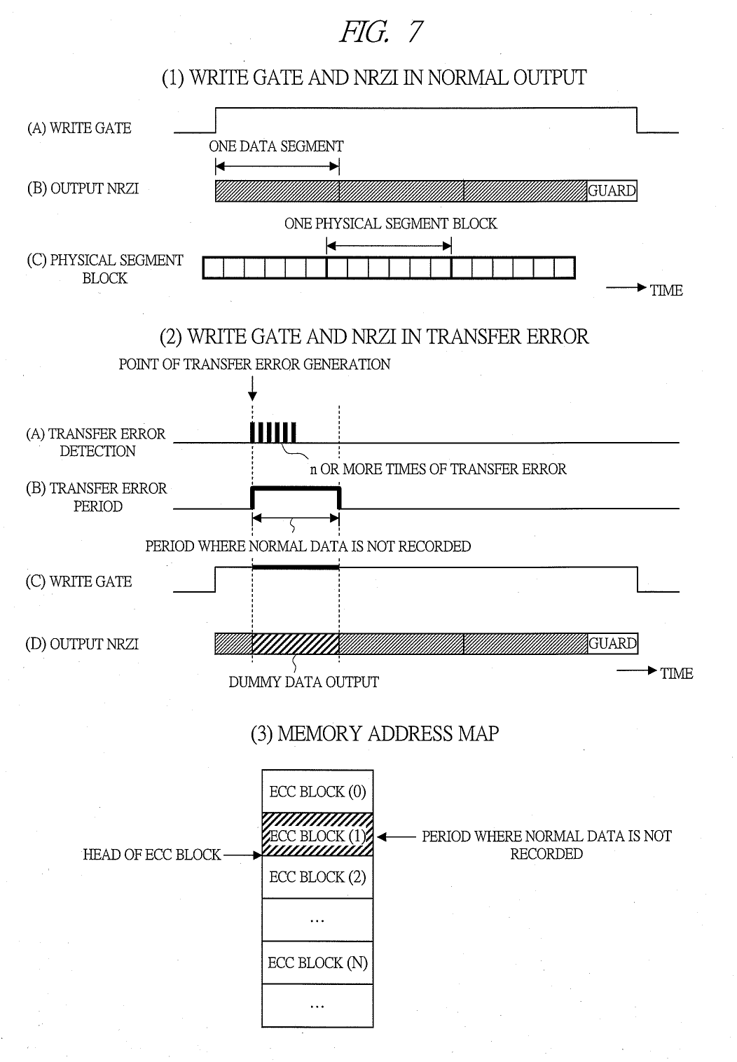

FIG. 7 is a view showing the write gate and the NRZI of the present embodiment. As shown in FIG. 7(2), when the transfer error is generated predetermined n number of times or more in units of sync frame, a period in which the normal data is not recorded for one ECC block including the location where the transfer error occurs is provided as the transfer error period. In this period, the write gate is not set to “L”, and a unique pattern similar to that described in the first embodiment is output as dummy data. Thereafter, the data having normal timing is output from the head of the next ECC block.

As shown in the memory address map of FIG. 7(3), the memory 190 is provided with plural ECC blocks. For instance, if the data of the ECC block (1) is the transfer error, data is output to the recording modulation circuit 300 from the head of the ECC block (2). The number of data of one ECC block is determined, and the memory arrangement of the data is also determined. Therefore, since the head position of each ECC block is known in advance, it is easy to output the data from the head position of the ECC block to the recording modulation circuit 300.

Also, since the length of the physical segment block and the length of the data segment are the same, the alignment with the NRZI can be performed again if the head position of the physical segment block is known by the address decoder 141, and the write of the correct data can be started from the correct position.

According to the optical disk apparatus 100 of the present embodiment, since one ECC block is sacrificed, the relevant portion is not correctly reproduced, but data will not be wasted compared to the case where reset is newly applied and re-recording is started from the position where the transfer error is generated. This is particularly effective in the case of stream data such as a video camera because retake is not possible.

### Third Embodiment

An optical disk apparatus according to a third embodiment of the present invention will be described below.

In the optical disk apparatuses of the first embodiment and the second embodiment, the dummy data is output without dropping the write gate at the point where the transfer error is detected. On the other hand, in the optical disk apparatus 100 of the present embodiment, the write gate is dropped at the point where the transfer error is detected, whereby the NRZI is not output from the recording modulation circuit 300 and the recording is not performed.

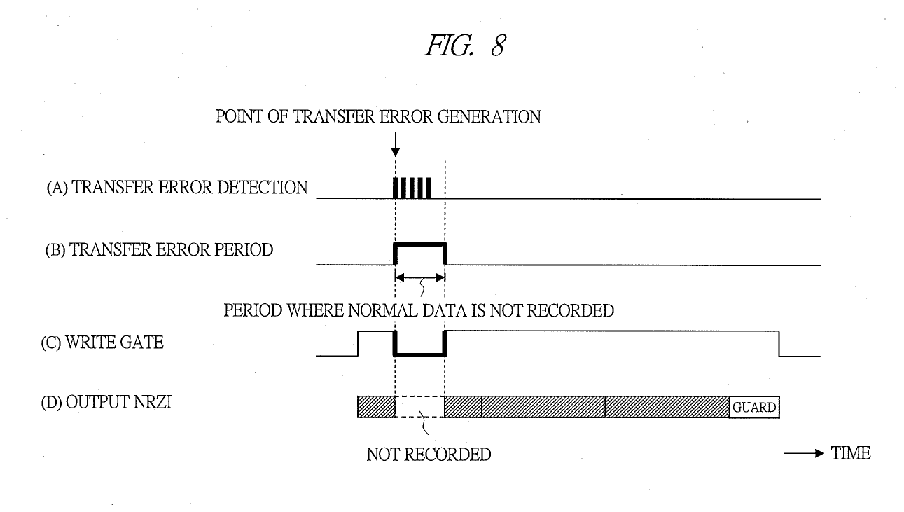

FIG. 8 is a view showing the write gate and the NRZI of the present embodiment. At the point where the transfer error is detected in the transfer error detection circuit 306, the write gate output from the recording clock synchronous processing circuit 311 is dropped, whereby the NRZI is not output and recording is not performed. Thereafter, if the transfer error is not output, the write gate may be raised at the head of the next sync frame.

According to the optical disk apparatus 100 of the present embodiment, since the dummy data output circuit 309 and the switch circuit 310 are not necessary, the circuit configuration is simplified and the LSI can be easily obtained. Note that, when the NRZI takes a fixed value of “0” or “1” in non-recording, the PLL in reproduction needs to have the function to detect and hold this region as the non-recorded region.

### Fourth Embodiment

An optical disk apparatus according to a fourth embodiment of the present invention will be described below.

In the optical disk apparatus of the present embodiment, the transfer error count circuit 307 for counting the number of transfer errors for every sync frame in the optical disk apparatus 100 of FIG. 1 is changed to that for counting the number of transfer errors for every sector. Note that it is also possible to provide a configuration in which whether the counting of the number of transfer errors in the transfer error count circuit 307 is performed for every sync frame or for every sector can be switched by settings.

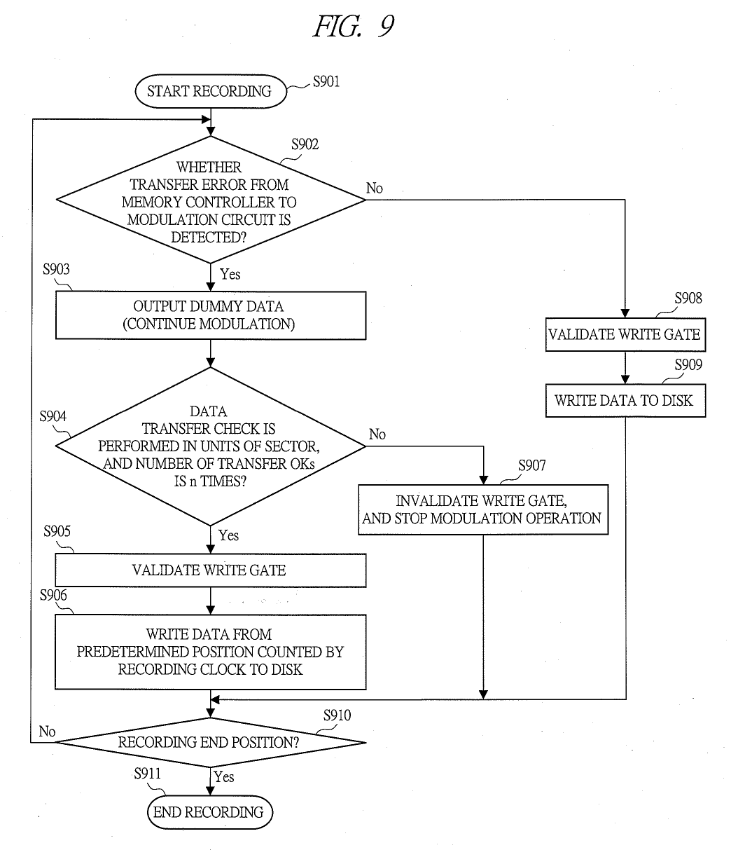

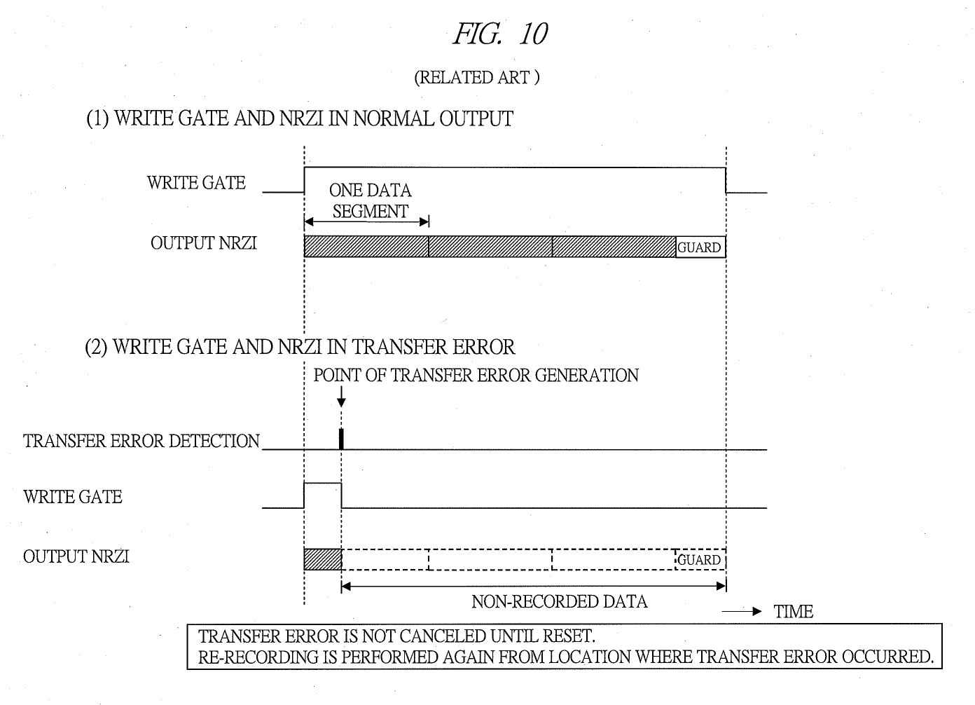

FIG. 9 is a flowchart of the operation when the transfer error is detected. The flowchart is the same as the flowchart shown in FIG. 5 of the first embodiment other than that the data transfer check is performed in units of sector in step 904.

As described above, in the current DVD, the error can be corrected even if the bust (continuous) error of 2714B (29 sync frames) is generated, and the burst error of at least 5904B (63 sync frames) can also be corrected in the HD DVD. Since one sector is 26 sync frames, the one sector can be restored by error correction at the time of reproduction even if the one sector becomes the dummy data, and high-speed recording becomes possible.

### Fifth Embodiment

An optical disk apparatus according to a fifth embodiment of the present invention will be described below.

In the first to fourth embodiments, an example of the optical disk apparatus directed to the DVD and the HD DVD has been described, but an example of the optical disk apparatus directed to the BD format will be described in the present embodiment.

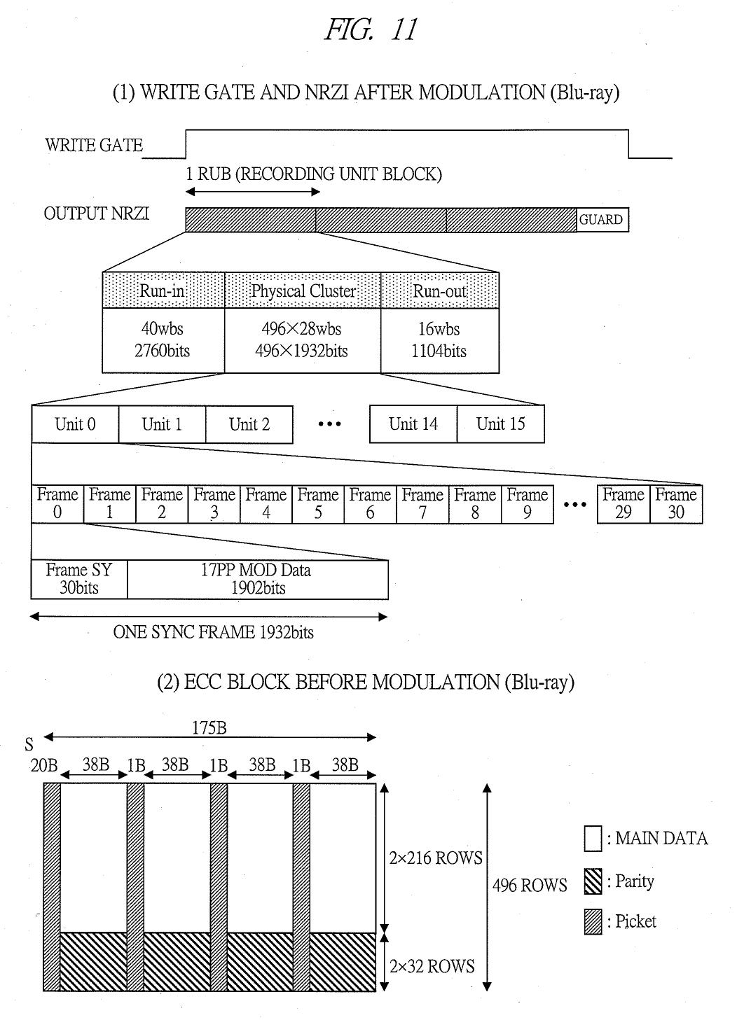

FIG. 11(1) shows a configuration of the write gate and the NRZI of the BD format after modulation, and FIG. 11(2) shows a configuration of the ECC block (error correction block) in the BD format. In the first to fourth embodiments described above, the description of the ECC block, the sync frame, and the like in the HD DVD has been made, but the names are different in the BD.

In FIG. 11(1), the data part for one section including the data for one ECC corresponding to one data segment of the HD DVD shown in FIG. 4(1) is referred to as one recording unit block (RUB) in BD. The data field indicating the data part in the HD DVD is referred to as physical cluster in BD. The physical cluster includes 16 units, and one unit includes 31 sync frames. Note that one wobble (described as wbs in the figure) corresponds to 69 channel bits.

As shown in FIG. 11(2), in the ECC block of BD, the picket code method is adopted in order to enhance the burst error detection capability. The main data is protected by the read Solomon code in the same manner as DVD. The picket is protected by a second read Solomon code separately from the main data. The picket column is corrected at the time of decoding, and the presence of burst error of the main data is predicted in the course of the correction. In BD, the user data of 64 KB is stored in one ECC block. Also, four picket columns are disposed at equal interval in one ECC block. S on the leftmost side is the synchronization pattern indicating the start of row. One ECC block of BD is configured of 175 bytes (B)×496 rows.

As described above, the BD greatly differs from the HD DVD in that the picket code is inserted in the ECC block, and the BD is the same as the HD DVD in that the ECC block data is generated using the memory 190 and the memory controller 170 of FIG. 1 and the NRZI is output in synchronization with the recording clock by performing a predetermined modulation process. In order to continuously output the NRZI in synchronization with the recording clock, the input/output control of data is performed in the memory controller 170 in the same manner as the first to fourth embodiments.

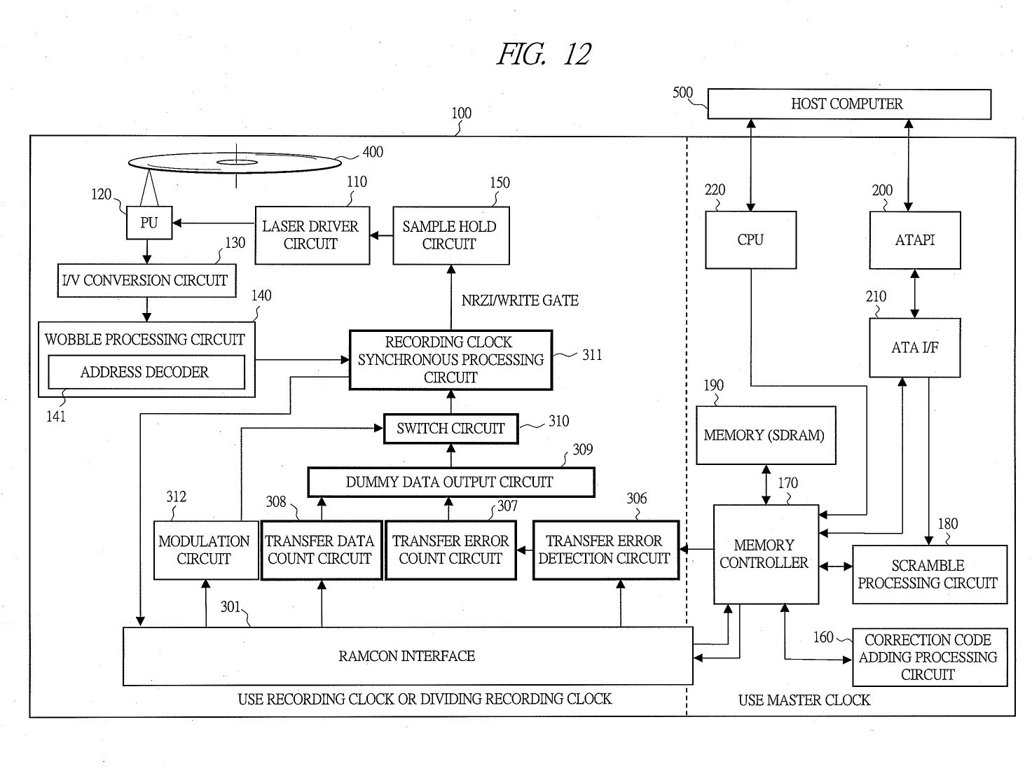

FIG. 12 shows a block diagram of the optical disk apparatus according to the present embodiment. In the optical disk apparatus 100 of the present embodiment, the processes subsequent to the process in the RAMCON interface 301 are performed by the recording clock or recording clock dividing process. The processes similar to those of the optical disk apparatus 100 having the configuration shown in FIG. 1 are performed in other aspects. Since the clock system is divided, the setting to change the master clock for each speed is not necessary, and the design can be simplified.

In the case of the BD format, the 17PP (Parity Preserve) modulation is performed by the modulation circuit 312, and the recording unit block (RUB) shown in FIG. 11(1) is generated and output to the switch circuit 310. The data after the modulation process or the dummy data is switched by the switch circuit 310, and the NRZI and the write gate are output to the sample hold circuit 150. Further, since a strong error correction is performed on the burst error in BD, the value of the set number of times n (n: positive integer) of the transfer error to be compared with the number of counts of the transfer error count circuit 307 can be set to a larger value than that in the HD DVD.

With the configuration as described above, even if the number of accesses to the CPU 220 and the ATAPI 200 suddenly increases, since the number of transfer errors is checked in the transfer error detection circuit 306 and the transfer error count circuit 307, the recording can be performed without interrupting when the number of transfer errors is less than the predetermined number of times, and thus high-speed recording can be realized. Further, since the dummy data portion is processed as the burst error in reproduction, correct data can be reproduced.

In the foregoing, the invention made by the inventors of the present invention has been concretely described based on the embodiments. However, it is needless to say that the present invention is not limited to the foregoing embodiments and various modifications and alterations can be made within the scope of the present invention.

The present invention can be applied to a recording modulation circuit and a recording modulation method used in recording digital data on an optical disk and an optical disk apparatus provided with the recording modulation circuit.

1. A recording modulation circuit for performing modulation in accordance with a modulation scheme for modulating a data word of i bits (i is a positive integer) to a code word of j bits (j is a positive integer) and outputting a signal obtained by converting an obtained modulation output data to code data and a write gate indicating a recording range of the modulation output data on an optical disk in an optical disk apparatus for recording digital data on an optical disk by light irradiation, the recording modulation circuit comprising:
means for detecting a transfer error on the data word read from a memory in the optical disk apparatus and input to the recording modulation circuit by a memory controller of the optical disk apparatus,
wherein, when the transfer error is detected, dummy data is output and a recording modulation operation is continued without being interrupted, and if the detection of the transfer error is stopped thereafter, the output of the modulation output data is resumed from a next sync frame.

2. The recording modulation circuit according to claim 1,
wherein a number of times of detection of the transfer error is counted for every sync frame, if the counted number of transfer errors is smaller than n (n: positive integer), the recording modulation operation is continued without being interrupted, and if the counted number of transfer errors is n or larger, the write gate is invalidated so that the modulation output data is not output.

3. The recording modulation circuit according to claim 2,
wherein, when the counted number of transfer errors is n or larger and the write gate is invalidated, if the detection of the transfer error is stopped thereafter, the invalidated write gate is validated, and the output of the modulation output data is resumed.

4. The recording modulation circuit according to claim 2,
wherein, when the counted number of transfer errors is n or larger, the dummy data equivalent to an ECC block where the transfer error is detected is output with the write gate being validated, and if the detection of the transfer error is stopped thereafter, the output of the modulation output data is resumed from a head of a next ECC block.

5. The recording modulation circuit according to claim 1,
wherein the dummy data is data of a unique array identifiable from a user data portion and a sync code portion in the modulation output data.

6. The recording modulation circuit according to claim 5,
wherein the dummy data is NRZI code data complying with the modulation scheme in an optical disk to be a recording target of the recording modulation circuit, and is data with an array in which DSV becomes 0.

7. The recording modulation circuit according to claim 6,
wherein the dummy data is data of a repetitive pattern with a channel bit length not corresponding to a range of a channel bit length used in the user data portion and the sync code portion in a format of code data in the optical disk to be the recording target of the recording modulation circuit, or the dummy data is data of a repetitive pattern with a channel bit length equal to that used in a guard portion.

8. The recording modulation circuit according to claim 2, further comprising:
means for holding the value n,
wherein the value n can be changed by setting from outside.

9. The recording modulation circuit according to claim 2,
wherein the number of times of detection of the transfer error is counted for every sector.

10. The recording modulation circuit according to claim 9,
wherein whether the number of times of detection of the transfer error is counted for every sync frame or for every sector can be switched by setting from outside.

11. A recording modulation circuit for performing modulation in accordance with a modulation scheme for modulating a data word of i bits (i is a positive integer) to a code word of j bits (j is a positive integer) and outputting a signal obtained by converting an obtained modulation output data to code data and a write gate indicating a recording range of the modulation output data on an optical disk in an optical disk apparatus for recording digital data on an optical disk by light irradiation, the recording modulation circuit comprising:
means for detecting a transfer error on the data word read from a memory in the optical disk apparatus and input to the recording modulation circuit by a memory controller of the optical disk apparatus,
wherein, when the transfer error is detected, the write gate is invalidated so that the modulation output data is not output, and if the detection of the transfer error is stopped thereafter, the invalidated write gate is validated, and output of the modulation output data is resumed from a next sync frame.

12. The recording modulation circuit according to claim 1,
wherein whether a function of recording modulation operation when the transfer error is detected is validated or not can be switched by setting from outside.

13. An optical disk apparatus for recording digital data on an optical disk by light irradiation, the optical disk apparatus comprising:
a recording modulation circuit for performing modulation in accordance with a modulation scheme for modulating a data word of i bits (i is a positive integer) to a code word of j bits (j is a positive integer) and outputting a signal obtained by converting an obtained modulation output data to code data and a write gate indicating a recording range of the modulation output data on an optical disk; and
a memory controller for reading out the data word from a memory and outputting the data word to the recording modulation circuit,
wherein the recording modulation circuit includes means for detecting transfer error of the data word from the memory controller to the recording modulation circuit, and
when the transfer error is detected, dummy data is output and a recording modulation operation is continued without being interrupted, and if the detection of the transfer error is stopped thereafter, output of the modulation output data is resumed.

14. An optical disk apparatus for recording digital data on an optical disk by light irradiation, the optical disk apparatus comprising:
a recording modulation circuit for performing modulation in accordance with a modulation scheme for modulating a data word of i bits (i is a positive integer) to a code word of j bits (j is a positive integer) and outputting a signal obtained by converting an obtained modulation output data to code data and a write gate indicating a recording range of the modulation output data on an optical disk; and
a memory controller for reading out the data word from a memory and outputting the data word to the recording modulation circuit,
wherein the recording modulation circuit includes means for detecting transfer error of the data word from the memory controller to the recording modulation circuit, and
when the transfer error is detected, the write gate is invalidated so that the modulation output data is not output, and if the detection of the transfer error is stopped thereafter, the invalidated write gate is validated, and output of the modulation output data is resumed from a next sync frame.

15. A recording modulation method in an optical disk apparatus comprising: a recording modulation circuit for performing modulation in accordance with a modulation scheme for modulating a data word of i bits (i is a positive integer) to a code word of j bits (j is a positive integer) and outputting a signal obtained by converting an obtained modulation output data to code data and a write gate indicating a recording range of the modulation output data on an optical disk; and
a memory controller for reading out the data word from a memory and outputting the data word to the recording modulation circuit,
wherein the optical disk apparatus executes the steps of:
detecting a transfer error of the data word from the memory controller to the recording modulation circuit;
outputting dummy data from the recording modulation circuit and continuing a recording modulation operation without interrupting when the transfer error is detected; and
resuming the output of the modulation output data from the recording modulation circuit from a next sync frame if the detection of the transfer error is stopped thereafter.

16. A recording modulation method in an optical disk apparatus comprising: a recording modulation circuit for performing modulation in accordance with a modulation scheme for modulating a data word of i bits (i is a positive integer) to a code word of j bits (j is a positive integer) and outputting a signal obtained by converting an obtained modulation output data to code data and a write gate indicating a recording range of the modulation output data on an optical disk; and
a memory controller for reading out the data word from a memory and outputting the data word to the recording modulation circuit,
wherein the optical disk apparatus executes the steps of:
detecting a transfer error of the data word from the memory controller to the recording modulation circuit;
invalidating the write gate so that the modulation output data is not output from the recording modulation circuit when the transfer error is detected, and
validating the invalidated write gate if the detection of the transfer error is stopped thereafter, and resuming the output of the modulation output data from a next sync frame.

17. An optical disk on which digital data is recorded by light irradiation,
wherein, by an optical disk apparatus which records the digital data on the optical disk, the optical disk apparatus including: a recording modulation circuit for performing modulation in accordance with a modulation scheme for modulating a data word of i bits (i is a positive integer) to a code word of j bits (j is a positive integer) and outputting a signal obtained by converting an obtained modulation output data to code data and a write gate indicating a recording range of the modulation output data on an optical disk; and a memory controller for reading out the data word from a memory and outputting the data word to the recording modulation circuit,
dummy data is recorded when transfer error of the data word from the memory controller to the recording modulation circuit is detected in the recording modulation circuit, and recording of the modulation output data is resumed if the detection of the transfer error is stopped thereafter.

18. An optical disk apparatus for recording digital data on an optical disk by light irradiation, the optical disk apparatus comprising:
a recording modulation circuit for performing modulation in accordance with a modulation scheme for modulating a data word of i bits (i is a positive integer) to a code word of j bits (j is a positive integer) and outputting a signal obtained by converting an obtained modulation output data to code data and a write gate indicating a recording range of the modulation output data on an optical disk;
a memory configuring an error correction block in which a parity is added to data and temporarily storing the same; and
a memory controller for controlling generation of the error correction block, reading out the error correction block from the memory and outputting the error correction block to the recording modulation circuit,
wherein, when generation of the error correction block is delayed for generation of the modulation output data output in synchronization with a recording clock in the recording modulation circuit due to that processes of the memory controller are occupied,
the recording modulation circuit continues recording modulation operation without interrupting if delay time of the output of the error correction block from the memory controller is within a range in which a burst error correction is possible at a time of reproduction of the optical disk.

19. An optical disk recording method in an optical disk apparatus, the optical disk apparatus comprising:
a recording modulation circuit for performing modulation in accordance with a modulation scheme for modulating a data word of i bits (i is a positive integer) to a code word of j bits (j is a positive integer) and outputting obtained modulation output data so as to record the same on an optical disk;
a memory configuring an error correction block in which a parity is added to data and temporarily storing the same; and
a memory controller for controlling generation of the error correction block, reading out the error correction block from the memory and outputting the error correction block to the recording modulation circuit,
wherein, when generation of the error correction block is delayed for generation of the modulation output data output in synchronization with a recording clock in the recording modulation circuit due to that processes of the memory controller are occupied,
the recording modulation circuit continues recording modulation operation without interrupting if delay time of the output of the error correction block from the memory controller is within a range in which a burst error correction is possible at a time of reproduction of the optical disk.

20. The recording modulation circuit according to claim 11,
wherein whether a function of recording modulation operation when the transfer error is detected is validated or not can be switched by setting from outside.
